(19) United States
(12) Patent Application Publication
(10) Pub. No.: US 2023/0260020 A1
(43) Pub. Date: Aug. 17, 2023

(54) PERSONAL LOAN-LENDING SYSTEM AND METHODS THEREOF

(71) Applicant: loanDepot.com, LLC, Irvine, CA (US)

(72) Inventors: Eileen Kim, Laguna Niguel, CA (US); Anne Eckles, Irvine, CA (US); Benjamin Lack, Ladera Ranch, CA (US); Maja Todorovic, Irvine, CA (US)

(73) Assignee: loanDepot.com, LLC, Irvine, CA (US)

(21) Appl. No.: 18/139,259

(22) Filed: Apr. 25, 2023

Related U.S. Application Data
(63) Continuation-in-part of application No. 16/443,555, filed on Jun. 17, 2019.
(60) Provisional application No. 62/687,046, filed on Jun. 19, 2018.

(51) Int. Cl. G06Q 40/03

(52) U.S. Cl. CPC G06Q 40/03

(57) ABSTRACT

Disclosed herein is a personal loan-lending system including, in some embodiments, a personal loan-originating system configured for originating personal loans, a personal loan-servicing system configured for servicing the personal loans, and third-party integration supporting the originating or the servicing of the personal loans. The third-party integration includes one or more application programming interfaces configured for transferring loan-related information between the personal loan-lending system and third parties such as credit bureaus, employment verification providers, or the like. The personal loan-lending system includes one or more server hosts supporting a personal loan-originating application stack and a personal loan-servicing application stack. Also disclosed herein are methods of the personal loan-lending system.

### PRIORITY

This application is a continuation-in-part of, and claims the benefit of, U.S. patent application, entitled “Personal Loan-Lending System And Methods Thereof,” filed on Jun. 17, 2019, and having application Ser. No. 16/443,555, which claims the benefit of, and priority to, U.S. Provisional Application, filed on Jun. 19, 2018 and having application Ser. No. 62/687,046, the entirety of each of said applications being incorporated herein by reference.

### FIELD

Embodiments of the present disclosure generally relate to the field of banking. More specifically, embodiments of the disclosure relate to a system for personal loan-lending and methods thereof.

### BACKGROUND

An important financial service provided by financial institutions is lending, which can include originating loans, servicing loans, or both originating and serving loans. There are many different types of loans available through such financial institutions. Broadly, the different types of loans are divided between secured loans and unsecured loans, wherein the secured loans are secured against borrowers' assets. Secured loans include, for example, mortgages, home equity loans, home equity lines of credit, or automotive loans. Unsecured loans include, for example, personal loans, personal lines of credit, student loans, or credit cards.

Lending, particularly originating loans such as personal loans, requires many fragmented, often manual processes of both borrowers and lenders. For a borrower, such processes include filling out a loan application and providing information in support of the loan application, the supporting information including, for example, employment, income, and liability information. For a lender, such processes include processing the borrower's loan application and verifying the supporting information, underwriting a potential loan and performing a detailed risk assessment in view of the supporting information, and, ultimately, upon approval from underwriting, funding the loan. Moreover, such processes are highly specific to loan type. This obviates any financial benefit from economies of scale that could otherwise be passed onto borrowers and lenders alike if such processes were more tightly integrated. Accordingly, there is a need for a more highly automated, more tightly integrated lending platform that facilitates lending for at least unsecured loan types such as personal loans.

Disclosed herein is a personal loan-lending system and methods thereof that address at least the foregoing need.

### SUMMARY

Disclosed herein is a personal loan-lending system including, in some embodiments, a personal loan-originating system configured for originating personal loans, a personal loan-servicing system configured for servicing the personal loans, and third-party integration supporting the originating or the servicing of the personal loans. The third-party integration includes one or more application programming interfaces (“APIs”) configured for transferring loan-related information between the personal loan-lending system and third parties. The personal loan-lending system includes one or more server hosts supporting a personal loan-originating application stack and a personal loan-servicing application stack.

In some embodiments, the personal loan-originating application stack includes a web server, an application server, a database server, and an e-mail server. Each server of the web server, the application server, the database server, and the e-mail server is configured to operate at least in part in a primary memory of at least one server host of the one or more server hosts.

In some embodiments, the personal loan-servicing application stack also includes a web server, an application server, a database server, and an e-mail server. Each server of the web server, the application server, the database server, and the e-mail server is configured to operate at least in part in a same primary memory of the at least one server host or a different primary memory of at least one other server host of the one or more server hosts.

In some embodiments, the application server is configured to provide at least a mobile web application configured to operate at least in part in a primary memory of a mobile device and present a borrower graphical user interface (“GUI”) within a mobile web browser on a touchscreen of a display of the mobile device. The borrower GUI is configured to allow potential borrowers to enter borrower-related information into a number of borrower-fillable sections of a digital application.

In some embodiments, the application server is configured to provide at least a web application configured to operate at least in part in a primary memory of a personal computer and present a lender GUI within a web browser on a screen of a monitor associated with the personal computer. The lender GUI is configured to allow a representative of the lender to review the borrower-related information entered in the number of sections of the digital application.

In some embodiments, the lender GUI is configured to allow the representative of the lender to send secured e-mail messages through the lender GUI by way of the e-mail server with automatic e-mail headers and attachments determined in accordance with a focus in the lender GUI on a particular borrower and loan process step.

In some embodiments, the number of sections of the digital application include a borrower-account registration section, a loan-purpose section, a borrower-profile section, an income-information section, an employment-history section, a banking-information section, or a combination thereof. Each section of the number of sections is configured to hold the borrower-related information until transferred to the database server and stored in a database on a storage device of the at least one server host of the one or more server hosts.

In some embodiments, the personal loan-originating application stack includes an automatic underwriting module. The automatic underwriting module is configured to perform detailed risk assessments in view of the borrower-related information transferred to the database server and stored in the database on the storage device of the at least one server host of the one or more server hosts.

In some embodiments, each section of the number of sections of the digital application optionally includes a graphical element configured to activate a servlet upon activation of the graphical element by a potential borrower. The servlet is configured to allow the potential borrowers to upload electronic copies or images of documents selected from at least driver's licenses, pay stubs, and bank statements.

In some embodiments, the personal loan-originating application stack includes an optical character recognition (“OCR”) module. The OCR module is configured to recognize text in uploaded images of documents, extract text from the images, and provide the text by way of the web server for automated filling of the borrower-related information.

In some embodiments, the borrower-related information from the banking information section transferred to the database server and stored in the database on the storage device of the at least one server host of the one or more server hosts is later used by the personal loan-originating system for automatically depositing personal-loan funds.

In some embodiments, the borrower-related information from the banking information section transferred to the database server and stored in the database on the storage device of the at least one server host of the one or more server hosts is later used by the personal loan-servicing system for automatically setting up monthly Automated Clearing House (“ACH”) payments on personal loans in accordance with terms of the personal loans, the terms ranging from 3 to 5 years.

Also disclosed herein is non-transitory computer-readable media (“CRM”) including executable instructions that, when executed on one or more server hosts by at least an equal number of processors, cause the one or more server hosts to instantiate a personal loan-lending system configured to perform a number of steps. The number of steps include, in some embodiments, instantiating a personal loan-originating application stack of a personal loan-originating system for originating personal loans, instantiating a personal loan-servicing application stack of a personal loan-servicing system for servicing the personal loans; and providing third-party integration supporting the originating or the servicing of the personal loans. The third-party integration includes one or more APIs configured for transferring loan-related information between the personal loan-lending system and third parties.

In some embodiments, the number of steps further include operating the personal loan-originating application stack at least in part in a primary memory of at least one server host of the one or more server hosts. The personal loan-originating application stack includes a web server, an application server, a database server, and an e-mail server.

In some embodiments, the number of steps further include operating the personal loan-servicing application stack at least in part in a same primary memory of the at least one server host or a different primary memory of at least one other server host of the one or more server hosts. The personal loan-servicing application stack includes a web server, an application server, a database server, and an e-mail server.

In some embodiments, the number of steps further include providing at least a mobile web application by way of the application server. The mobile web application is configured to operate at least in part in a primary memory of a mobile device and present a borrower GUI within a mobile web browser on a touchscreen of a display of the mobile device. The borrower GUI is configured to allow potential borrowers to enter borrower-related information into a number of borrower-fillable sections of a digital application.

In some embodiments, the number of steps further include providing at least a web application by way of the application server. The web application is configured to operate at least in part in a primary memory of a personal computer and present a lender GUI within a web browser on a screen of a monitor associated with the personal computer. The lender GUI is configured to allow a representative of the lender to review the borrower-related information entered in the number of sections of the digital application.

In some embodiments, the number of steps further include sending secured e-mail messages through the lender GUI by way of the e-mail server. The lender GUI is configured to allow the representative of the lender to send the secured e-mail messages with automatic e-mail headers and attachments determined in accordance with a focus in the lender GUI on a particular borrower and loan process step.

In some embodiments, the number of steps further include transferring to the database server and storing in a database on a storage device of the at least one server host of the one or more servers borrower-related information held in the number of sections of the digital application. The number of sections of the digital application for the personal loan include a borrower-account registration section, a loan-purpose section, a borrower-profile section, an income-information section, an employment-history section, a banking-information section, or a combination thereof.

In some embodiments, the number of steps further include automatically underwriting with an automatic underwriting module of the personal loan-originating application stack. The automatic underwriting module is configured to perform detailed risk assessments in view of the borrower-related information transferred to the database server and stored in the database on the storage device of the at least one server host of the one or more server hosts.

In some embodiments, the number of steps further include providing a servlet configured to allow the potential borrowers to upload electronic copies or images of documents selected from at least driver's licenses, pay stubs, and bank statements. Each section of the number of sections of the digital application optionally includes a graphical element configured to activate the servlet upon activation of the graphical element by a potential borrower and upload the electronic copes or images of documents.

In some embodiments, the number of steps further include recognizing text in uploaded images of documents with an OCR module of the personal loan-originating application stack, extracting text from the uploaded images of documents with the OCR module, and providing the text by way of the web server for automated filling of the borrower-related information.

In some embodiments, the number of steps further include automatically depositing personal-loan funds by way of the personal loan-originating system. The borrower-related information from the banking information section transferred to the database server and stored in the database on the storage device of the at least one server host of the one or more server hosts is used for automatically depositing the personal-loan funds.

In some embodiments, the number of steps further include automatically setting up monthly ACH payments by way of the personal loan-originating system on personal loans in accordance with terms of the personal loans. The borrower-related information from the banking information section transferred to the database server and stored in the database on the storage device of the at least one server host of the one or more server hosts is used for automatically setting up the monthly ACH payments.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 provides a schematic illustrating an integrated lending-and-brokering environment including a lending platform in accordance with some embodiments;

FIG. 2 provides a schematic illustrating the lending platform including the personal loan-lending system in accordance with some embodiments;

FIG. 3A provides a schematic illustrating a personal loan-originating system of the personal loan-lending system in accordance with some embodiments;

FIG. 3B provides a schematic illustrating a borrower interface of a web application of the personal loan-originating system in accordance with some embodiments;

FIG. 4 provides a schematic illustrating a personal loan-servicing system of the personal loan-lending system in accordance with some embodiments;

FIG. 5 provides a schematic illustrating the personal loan-lending system supported by a number of server hosts networked with a number of client hosts in accordance with some embodiments;

FIG. 6 provides a schematic illustrating a process of the personal loan-originating system in accordance with some embodiments;

FIG. 7 provides a schematic illustrating a process of the personal loan-servicing system in accordance with some embodiments;

FIG. 8 provides a schematic illustrating components of a network host in accordance with some embodiments; and

FIG. 9 provides an exemplary a block diagram that illustrates an exemplary computing system that may be used in conjunction with an integrated lending-and-brokering environment in accordance with some embodiments.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

Before some particular embodiments are disclosed in greater detail, it should be understood that the particular embodiments disclosed herein do not limit the scope of the concepts provided herein. It should also be understood that a particular embodiment disclosed herein can have features that can be readily separated from the particular embodiment and optionally combined with or substituted for features of any of a number of other embodiments disclosed herein.

Regarding terms used herein, it should also be understood the terms are for the purpose of describing some particular embodiments, and the terms do not limit the scope of the concepts provided herein. Ordinal numbers (e.g., first, second, third, etc.) are generally used to distinguish or identify different features or steps in a group of features or steps, and do not supply a serial or numerical limitation. For example, “first,” “second,” and “third” features or steps need not necessarily appear in that order, and the particular embodiments including such features or steps need not necessarily be limited to the three features or steps. Labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. Singular forms of “a,” “an,” and “the” include plural references unless the context clearly dictates otherwise.

Unless defined otherwise, all technical and scientific terms used herein have the same meaning as commonly understood by those of ordinary skill in the art.

As previously set forth, lending requires many fragmented, often manual processes of both borrowers and lenders. Moreover, such processes are highly specific to loan type. This obviates any financial benefit from economies of scale that could otherwise be passed onto borrowers and lenders alike if such processes were more tightly integrated and generalized across the loan types. Accordingly, there is a need for a more highly automated, more tightly integrated lending platform that dissolves lines between lending for secured and unsecured loan types.

Disclosed herein is a personal loan-lending system and methods thereof that address at least the foregoing need.

For example, a personal loan-lending system is disclosed herein including, in some embodiments, a personal loan-originating system configured for originating personal loans, a personal loan-servicing system configured for servicing the personal loans, and third-party integration supporting the originating or the servicing of the personal loans. The third-party integration includes one or more application programming interfaces configured for transferring loan-related information between the personal loan-lending system and third parties such as credit bureaus, employment verification providers, or the like. The personal loan-lending system includes one or more server hosts supporting a personal loan-originating application stack and a personal loan-servicing application stack. Also disclosed herein are methods of the personal loan-lending system.

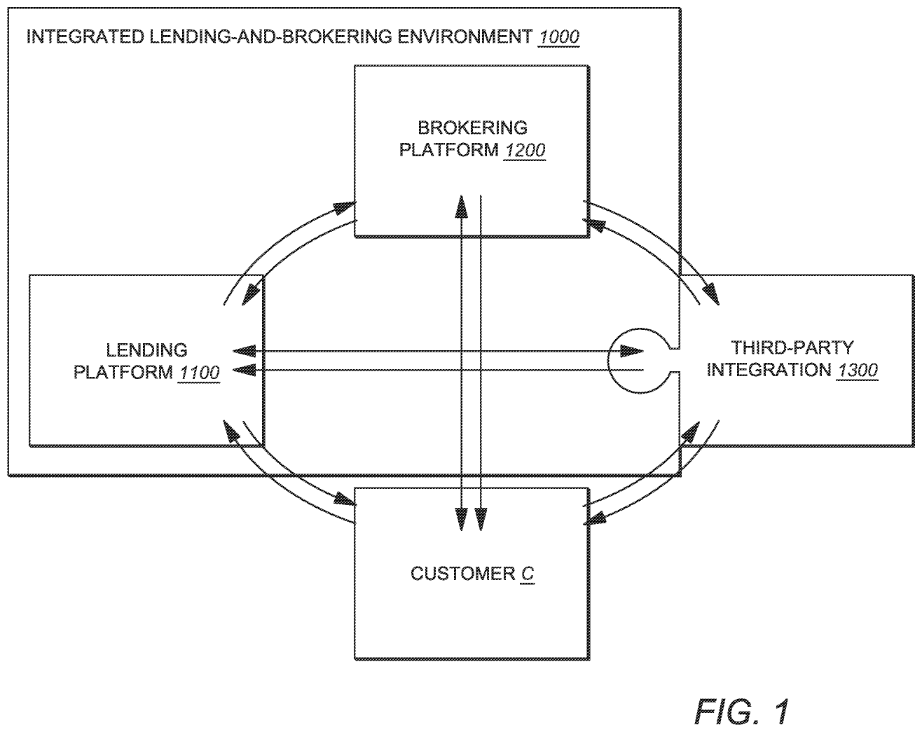

FIG. 1 provides a schematic illustrating an integrated lending-and-brokering environment 1000 including a lending platform 1100 in accordance with some embodiments.

As shown in FIG. 1, the integrated lending-and-brokering environment 1000 includes, in some embodiments, the lending platform 1100, a brokering platform 1200, and third-party integration 1300, wherein the integrated lending-and-brokering environment 1000 is configured for information sharing such that at least a customer need not provide duplicative customer information to any systems of the integrated lending-and-brokering environment 1000 or any personnel associated therewith. The lending platform 1100 is configured for gathering and processing lending-related information for originating loans, servicing loans, or both, wherein the loans are selected from unsecured loans and secured loans. The brokering platform 1200 is configured for gathering and processing brokering-related information for buying assets, selling assets, buying services related to selling the assets, or a combination thereof, wherein the assets include real estate, and wherein the services include services for improving such real estate (e.g., home improvement-related services). The third-party integration 1300 includes one or more interfaces with the lending-and-brokering environment 1000 such as one or more APIs, one or more web applications, or at least one API and at least one web application. The third-party integration 1300 allows the one or more third-parties to at least contribute additional information for the processing of the lending-related information, the brokering-related information, or both.

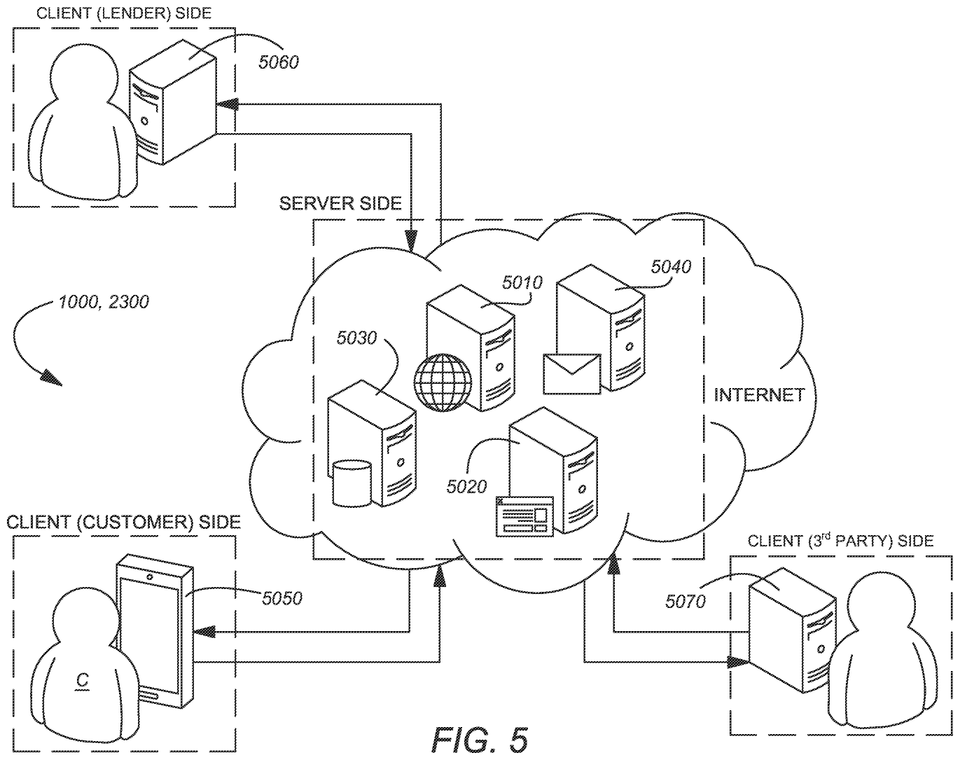

It is contemplated that, in some embodiments, the lending platform 1100 may include an artificial intelligence (AI) model that can be configured to accurately perform one or more of the steps comprising automatically underwriting loans, as described herein. For example, the server host 5020 (see FIG. 5) can include an AI module that may be configured to train one or more AI (e.g., machine learning or other suitable AI) modules to perform one or more steps of the invention. In some embodiments, a neural network may be utilized. In some embodiments, the AI modules may be trained on dataset(s) representing user account histories and/or previous readjustments, determinations, qualifying offers, weights, metrics, thresholds, qualifying scores, or any other suitable or relevant training data. In some embodiments, the AI modules may be trained on specific user account(s) and/or credit history.

In some embodiments, the AI module may be configured to self-correct and improve based on a reward feedback circuit for modifying the one or more assigned weights and/or unique thresholds. For example, upon a readjustment of weights of metrics, the readjustment values can be measured as leading to a desired outcome or an undesired outcome according to one or more criteria, then fed back into the AI module as training data. As the AI module further trains on the readjustments it makes and whether those readjustments are desirable or undesirable, the AI module self-corrects and improves as it continues to make readjustments. A wide variety of potential AI modules can be employed for such a self-correcting technique. In some embodiments, one or more AI modules may be used in a similar manner for other determinations, computations, and/or predictions within the system. In some embodiments, one or more AI modules may be configured to automatically generate any one or more of metrics, weights, thresholds, tiers, qualifying scores for tiers, qualifying offers, reports, or any other suitable aspect of the systems described herein, without limitation. In some embodiments, such AI modules may be configured to similarly self-correct and improve this generation based on feedback reward circuits.

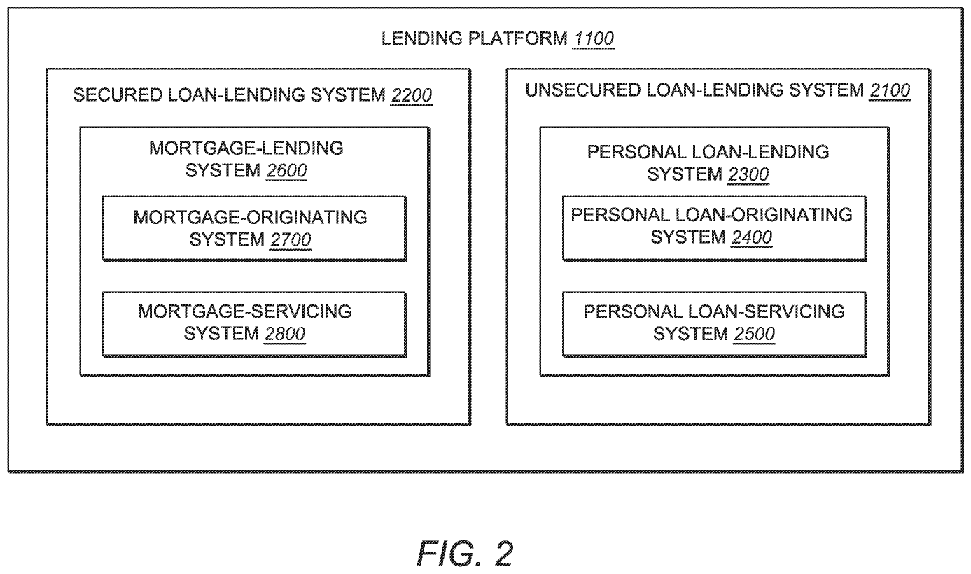

FIG. 2 provides a schematic illustrating the lending platform 1100 including a personal loan-lending system 2300 in accordance with some embodiments.

As shown in FIG. 2, the lending platform 1100 includes an unsecured loan-lending system 2100 and a secured loan-lending system 2200. The unsecured loan-lending system 2100 includes at least the personal loan-lending system 2300 having a personal loan-originating system 2400 and a personal loan-servicing system 2500. The personal loan-originating system 2400 is configured for originating personal loans. The personal loan-servicing system 2500 is configured for servicing the personal loans. The personal-loan lending system 2300 includes one or more server hosts (see FIG. 5) supporting at least a personal loan-originating application stack for originating the personal loans and a personal loan-servicing application stack for servicing the personal loans. The secured loan-lending system 2200 includes at least a mortgage-lending system 2600 having a mortgage-originating system 2700 and a mortgage-servicing system 2800.

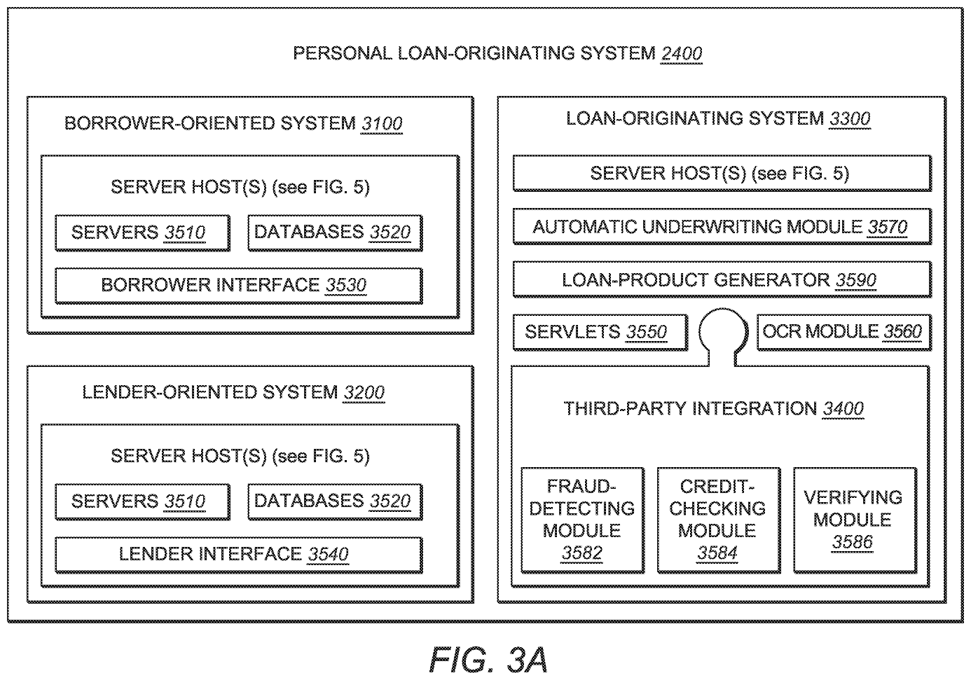

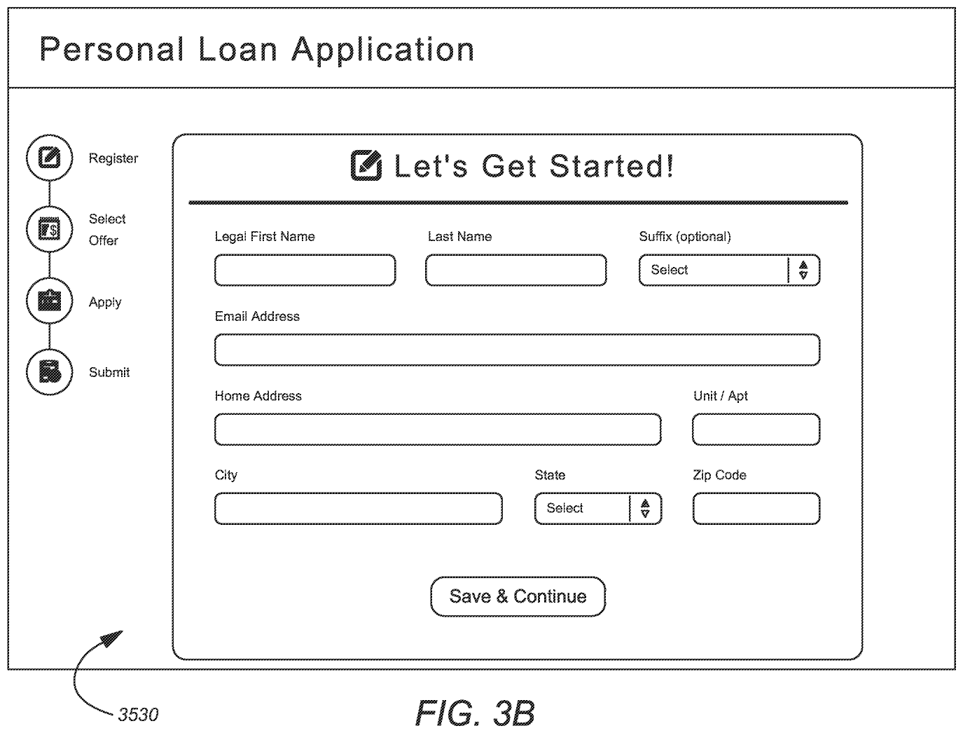

FIG. 3A provides a schematic illustrating the personal loan-originating system 2400 of the personal loan-lending system 2300 in accordance with some embodiments. As shown in FIG. 3A, the personal loan-originating system 2400 includes a borrower-oriented system 3100, a lender-oriented system 3200, a loan-originating subsystem 3300 for at least loan-application processing, and third-party integration 3400 supporting personal-loan origination.

Again, the personal-loan lending system 2300 includes one or more server hosts (see FIG. 5). The one or more server hosts can be shared among at least the borrower-oriented system 3100, the lender-oriented system 3200, and the loan-originating subsystem 3300 of the personal loan-originating system 2400. That said, each system of the borrower-oriented system 3100, the lender-oriented system 3200, and the loan-originating subsystem 3300 can alternatively or additionally include one or more dedicated server hosts as needed.

The personal loan-originating application stack for originating the personal loans includes a web server, an application server, a database server, one or more databases, and an e-mail server. Collectively, such servers and databases are respectively shown in FIG. 3A as servers 3510 and databases 3520. Each server of the web server, the application server, the database server, and the e-mail server is configured to operate at least in part in a primary memory of at least one server host of the one or more server hosts.

The application server is configured to provide at least a web application configured to operate at least in part in a primary memory of a computer system and present a borrower interface 3530, or borrower GUI 3530, within a web browser on a screen of a display of the computer system. For example, the application server is configured to provide a mobile web application configured to operate at least in part in a primary memory of a mobile device and present a borrower GUI within a mobile web browser on a touchscreen of a display of the mobile device. The borrower GUI 3530 is configured to allow potential borrowers to enter borrower-related information into a number of borrower-fillable sections of a digital application.

FIG. 3B provides a schematic illustrating the borrower interface 3530 of a web application of the personal loan-originating system 2400 in accordance with some embodiments.

The number of borrower-fillable sections of the digital application include a borrower-account registration section as shown in FIG. 3B, as well as a loan-purpose section, a borrower-profile section, an income-information section, an employment-history section, a banking-information section, or one or more combinations of the foregoing borrower-fillable sections. Such sections are not presented to a potential borrower all at once in order to avoid inundating the potential borrower, as inundating the potential borrower can reduce quality of the borrower-related information provided by the borrow in the number of borrower-fillable sections. Each section of the number of sections is configured to hold the borrower-related information until transferred to the database server and stored in a database of the one or more databases 3540 on a storage device of the at least one server host of the one or more server hosts. As such, a digital application for a potential borrower can exist in an incomplete state in the database of the one or more databases 3540. Furthermore, the borrower interface 3530 exemplified in FIG. 3B exists in a borrower-recognizable state corresponding to the incomplete state of the digital application in the database of the one or more databases 3540. For example, if the potential borrower has finished with the borrower-account registration but has not selected an offer in accordance with the next section of the digital application as shown in FIG. 3B, this is recorded in the database of the one or more databases 3540 and recognized by the potential borrower in the borrower interface as a required step for moving to the next section of the digital application. The borrower-related information from the banking information section transferred to the database server and stored in the one or more databases 3540 on a storage device of the at least one server host of the one or more server hosts is later used by the personal loan-originating system for automatically depositing personal-loan funds.

Each section of the number of sections of the digital application optionally includes one or more graphical elements such as an on-screen button (see, for example, button labeled “Save & Continue” in FIG. 3B) configured to respectively activate one or more servlets 3550 (see FIG. 3A) of the loan-originating subsystem 3300 upon activation by a potential borrower. One or more of the servlets is configured to allow the potential borrowers to upload electronic copies or images of documents selected from at least driver's licenses, pay stubs, and bank statements.

In association with the foregoing servlets, the personal loan-originating system 2400 also includes an OCR module 3560 as shown in FIG. 3A. The OCR module 3560 is configured to recognize text in uploaded images of documents, extract text from the images, and provide the text by way of the web server for automated filling of the borrower-related information.

Adverting to FIG. 3A, the application server is also configured to provide at least a web application configured to operate at least in part in a primary memory of another computer system and present a lender interface 3540, or lender GUI 3540, within a web browser on a screen of a display of the computer system. For example, the application server is configured to provide at least a web application configured to operate at least in part in a primary memory of a personal computer and present a lender GUI within a web browser on a screen of a monitor associated with the personal computer. The lender GUI 3540 is configured to allow a representative of the lender to review the borrower-related information entered in the number of sections of the digital application.

The lender GUI 3540 is configured to allow the representative of the lender to send secured e-mail messages through the lender GUI 3540 by way of the e-mail server with automatic e-mail headers and attachments determined in accordance with a focus in the lender GUI 3540 on a particular borrower and loan process step. The secured e-mail messages can solicit additional borrower-related information and direct recipient borrower to one or more pages of a web site or the borrower GUI 3530 to upload electronic copies or images of documents.

The personal loan-originating system 2400 includes an automatic underwriting module 3570 configured to perform detailed risk assessments in view of the borrower-related information transferred to the database server and stored in the one or more databases 3540 on the storage device of the at least one server host of the one or more server hosts. The third-party integration 3400 includes one or more API modules such as a fraud-checking module 3582, credit-checking module 3584, and a verifying module 3586 configured for transferring loan-related information between the personal loan-originating system 2400 and third parties such as fraud-detecting companies bureaus, credit bureaus, employment-verification providers, or other third-party vendors.

The personal loan-originating system 2400 can include a loan-product generator 3590 configured to generate different loan products from which potential borrowers can choose once at least some of the borrower-related information from the digital application is processed.

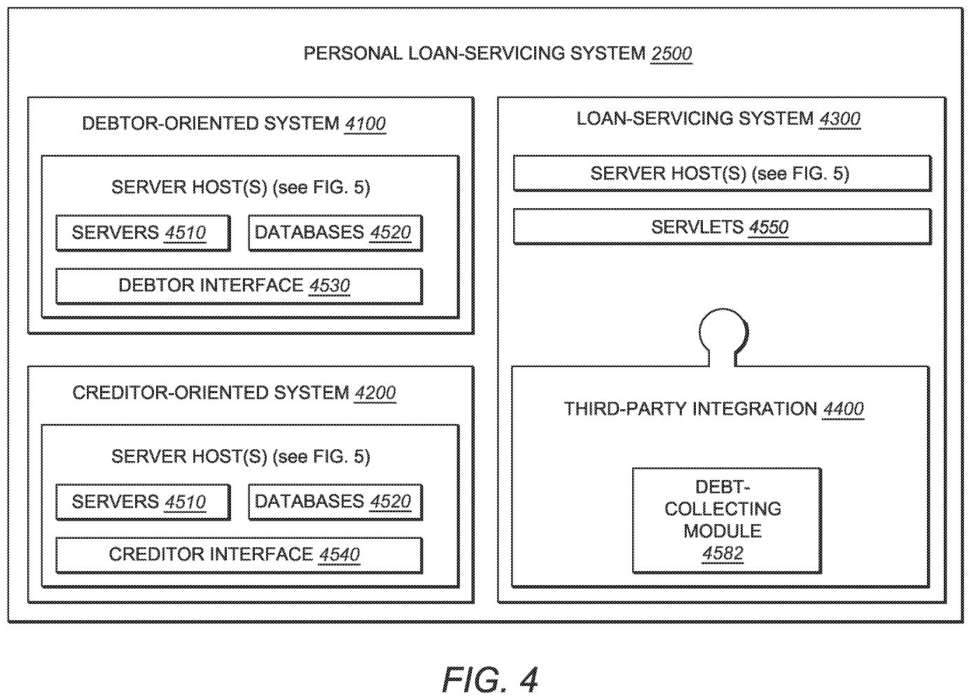

FIG. 4 provides a schematic illustrating a personal loan-servicing system 2116 of the personal loan-lending system 2112 in accordance with some embodiments.

As shown in FIG. 4, the personal loan-servicing system 2500 includes a debtor-oriented system 4100, a creditor-oriented system 4200, a loan-servicing subsystem 4300, and third-party integration 4400 supporting personal-loan servicing. Again, the personal-loan lending system 2300 includes one or more server hosts (see FIG. 5). The one or more server hosts can be shared among at least the debtor-oriented system 4100, the creditor-oriented system 4200, and the loan-servicing subsystem 4300 of the personal loan-servicing system 2500. That said, each system of the debtor-oriented system 4100, the creditor-oriented system 4200, and the application-processing system 4300 can alternatively or additionally include one or more dedicated server hosts as needed.

The personal loan-servicing application stack for servicing the personal loans includes a web server, an application server, a database server, one or more databases, and an e-mail server. Collectively, such servers and databases are respectively shown in FIG. 4 as servers 4510 and databases 4520. Each server of the web server, the application server, the database server, and the e-mail server is configured to operate at least in part in a primary memory of at least one server host of the one or more server hosts.

The application server is configured to provide at least a web application configured to operate at least in part in a primary memory of a computer system and present a debtor interface 4530, or debtor GUI 4530, within a web browser on a screen of a display of the computer system. For example, the application server is configured to provide a mobile web application configured to operate at least in part in a primary memory of a mobile device and present a debtor GUI within a mobile web browser on a touchscreen of a display of the mobile device. The debtor GUI 4530 is configured to allow borrowers to pay down existing personal loans.

The debtor GUI 4530 optionally includes one or more graphical elements such as an on-screen button (see, for example, button labeled “Save & Continue” in FIG. 3B) configured to respectively activate one or more servlets 4550 (see FIG. 3A) of the loan-servicing subsystem 4300 upon activation by a debtor. One or more of the servlets is configured to allow the debtor to transfer funds by way of an ACH transfer from a linked bank account to pay down an existing personal loan.

The borrower-related information from the banking information section of the digital application transferred to the database server and stored in the one or more databases 3540 on the storage device of the at least one server host of the one or more server hosts can be used by the personal loan-servicing system 2500 for automatically setting up monthly ACH payments on personal loans in accordance with terms of the personal loans, which terms range from 3 to 5 years.

The application server is also configured to provide at least a web application configured to operate at least in part in a primary memory of another computer system and present a creditor interface 4540, or creditor GUI 4540, within a web browser on a screen of a display of the computer system. For example, the application server is configured to provide at least a web application configured to operate at least in part in a primary memory of a personal computer and present a creditor GUI within a web browser on a screen of a monitor associated with the personal computer. The creditor GUI 3540 is configured to allow a representative of the creditor to review the borrower-related information for debtors with existing personal loans.

The third-party integration 4400 includes one or more API modules such as a debt-collecting module 4582 configured for transferring loan-related information between the personal loan-servicing system 2500 and third parties such as debt collectors.

FIG. 5 provides a schematic illustrating the personal loan-lending system 2112 supported by a number of server hosts networked with a number of client hosts in accordance with some embodiments.

The integrated lending-and-brokering environment 1000 includes one or more application stacks such as the personal loan-originating application stack and the personal loan-servicing application stack. Each application stack is independently configured to run at least in part from a primary memory of at least one server host of the server hosts 5010, 5020, 5030, and 5040 of the lending-and-brokering environment 1000.

As shown in FIG. 5, the server hosts 5010, 5020, 5030, and 5040 supporting the integrated lending-and-brokering environment 1000 and the one or more application stacks thereof can include a web server, an application server, a database server with an associated database, an e-mail server configured to send and receive secured e-mail messages, or a combination thereof. For expository convenience, the server host 5010 is shown to support the web server, the server host 5020 is shown to support the application server, the server host 5030 is shown to support the database server, and the server host 5040 is shown to support the e-mail server; however, the web server, the application server, the database server, and the e-mail server can be supported by any one or more of the server hosts 5010, 5020, 5030, and 5040 in any of a number of ways. Optionally, the server hosts 5010, 5020, 5030, and 5040 further support mobile device-oriented server counterparts such as a mobile web server or a mobile application server if such mobile device-oriented server counterparts are not already integrated with their counterpart servers.

With respect to the personal loan-originating application stack for originating personal loans, an application server of the personal loan-originating application stack supported by, for example, the server host 5020 can include a borrower-oriented web application server module (not shown) configured to service requests from one of more client hosts such as a borrower's client host 5050 for a borrower-oriented web application (e.g., the borrower GUI 3530). The borrower-oriented web application server module can be a mobile web application server module configured to service requests from one of more mobile devices (e.g., smart phones, tablet computers, etc.) for a mobile web application version of the borrower-oriented web application. The personal loan-originating application stack can also include a lender-oriented web application server module (not shown) configured to service requests from one of more client hosts such as a lender's client host 5060 for a lender-oriented web application (e.g., the lender GUI 3540). The lender-oriented web application server module can be a mobile web application server module configured to service requests from one of more mobile devices (e.g., smart phones, tablet computers, etc.) for a mobile web application version of the lender-oriented web application.

With respect to the personal loan-servicing application stack for servicing personal loans, an application server of the personal loan-servicing application stack supported by, for example, the server host 5020 can include a debtor-oriented web application server module (not shown) configured to service requests from one of more client hosts such as a borrower's client host 5050 for a debtor-oriented web application (e.g., the debtor GUI 4530). The debtor-oriented web application server module can be a mobile web application server module configured to service requests from one of more mobile devices (e.g., smart phones, tablet computers, etc.) for a mobile web application version of the debtor-oriented web application. The personal loan-servicing application stack can also include a creditor-oriented web application server module (not shown) configured to service requests from one of more client hosts such as a creditor's client host 5060 for a creditor-oriented web application (e.g., the creditor GUI 4540). The creditor-oriented web application server module can be a mobile web application server module configured to service requests from one of more mobile devices (e.g., smart phones, tablet computers, etc.) for a mobile web application version of the creditor-oriented web application.

With respect to any third party-oriented application stack, an application server of the third party-oriented application stack supported by, for example, the server host 5020 can include a third party-oriented web application server module (not shown) configured to service requests from one of more client hosts such as a third party's client host 5070 for a third party-oriented web application. The third party-oriented web application server module can be a mobile web application server module configured to service requests from one of more mobile devices (e.g., smart phones, tablet computers, etc.) for a mobile web application version of the third party-oriented web application.

While the foregoing sets forth a number of web applications for client hosts, it should be understood that such client hosts can alternatively run local applications native to the operating systems of the client hosts.

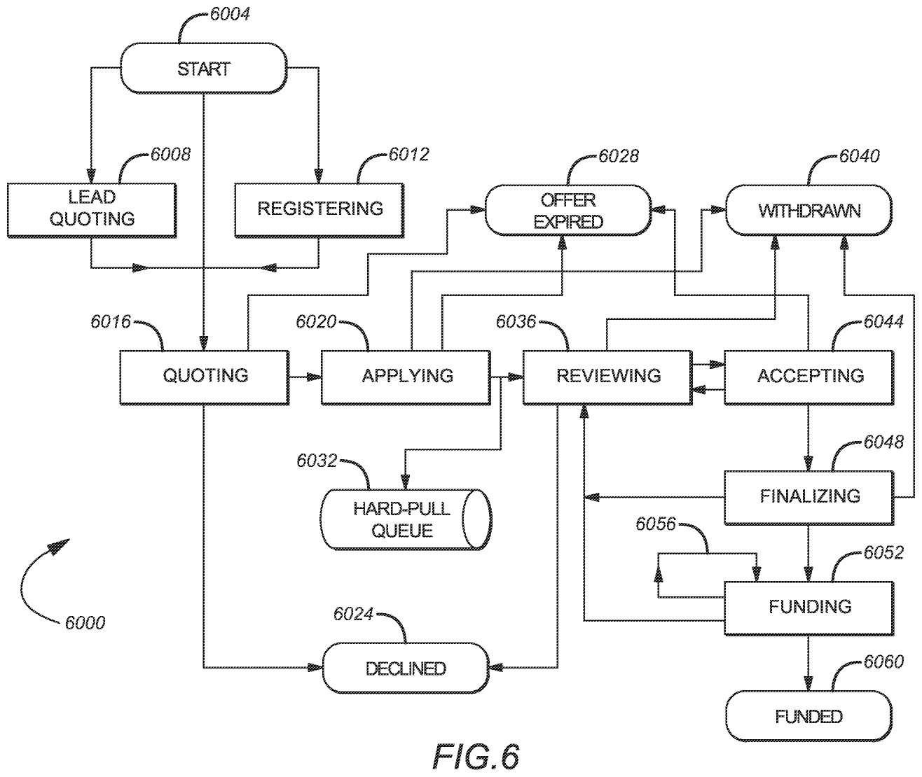

FIG. 6 provides a schematic illustrating a process 6000 by which potential borrowers and representatives of the lender interact by way of the personal loan-originating system 2400 in accordance with some embodiments. The process 6000 generally illustrates one embodiment whereby a personal loan is successfully funded. The process 6000 begins at a start step 6004 wherein a borrower seeks a personal loan. The borrower may begin the process 6000 as an external lead 6008 or by way of a registration step 6012, wherein the borrower creates an account. The process 6000 moves to a quotation step 6016 wherein the borrower receives one or more offers. When the borrower selects an offer, the process 6000 advances to an application step 6020. In some instances, however, a credit/fraud/pricing engine may decline the borrower, in which case the process 6000 moves the borrower to a declined step 6024. Further, in some instances, the borrower may neglect to select from among the offers presented in step 6016. When the borrower fails to select an offer, the process 6000 may move to an offer expired step 6028.

While at the application step 6020, the borrower may be prompted to complete an application for the personal loan. Upon completing the application, the borrower's application may be placed into a hard-pull queue 6032 until a hard inquiry into the borrower's credit history may be performed. It is contemplated that the hard inquiry may be performed by an underwriter at a reviewing step 6036. In some instances, however, wherein the borrower does not complete the application in step 6020, the process moves to the offer expired step 6028. Further, in some instances the borrower may voluntarily withdraw the application during either the application step 6020 or the reviewing step 6036. In such instances, the process 6000 may move to a withdrawn step 6040. Moreover, the underwriter or a fraud analyst may decline the borrower's application during the reviewing step 6036, in which case the process 6000 may move to the declined step 6024.

When the underwriter approves the borrower's application, the process 6000 may move from step 6036 to an accepting step 6044. As shown in FIG. 6, the process 6000 may move between steps 6036, 6044 during underwriting and preparation of final documents. If the borrower fails to accept the final documents, the process 6000 may move to the offer expired step 6028. However, if the borrower does accept the final documents, the process 6000 may advance to a finalizing step 6048. During the finalizing step 6048, the final documents may be subjected to a quality control analysis wherein critical variables in the final documents are checked for accuracy. If additional verification is needed, the process 6000 may return to the reviewing step 6036. Further, if the borrower withdraws the application, the process 6000 may move to the withdrawn step 6040.

Once final verification of the application is completed, the process 6000 moves to a funding step 6052. During step 6052, the final loan documents and an ACH request are sent to a lender. If the lender rejects the ACH request, the funding step 6052 may resubmit the ACH request, 6056, or refer the loan documents back to the reviewing step 6036 for further underwriting and analysis. If the lender accepts the ACH request, the process advances to step 6060 wherein the borrower receives net proceeds by ACH and a loan boarding file is sent to the servicer.

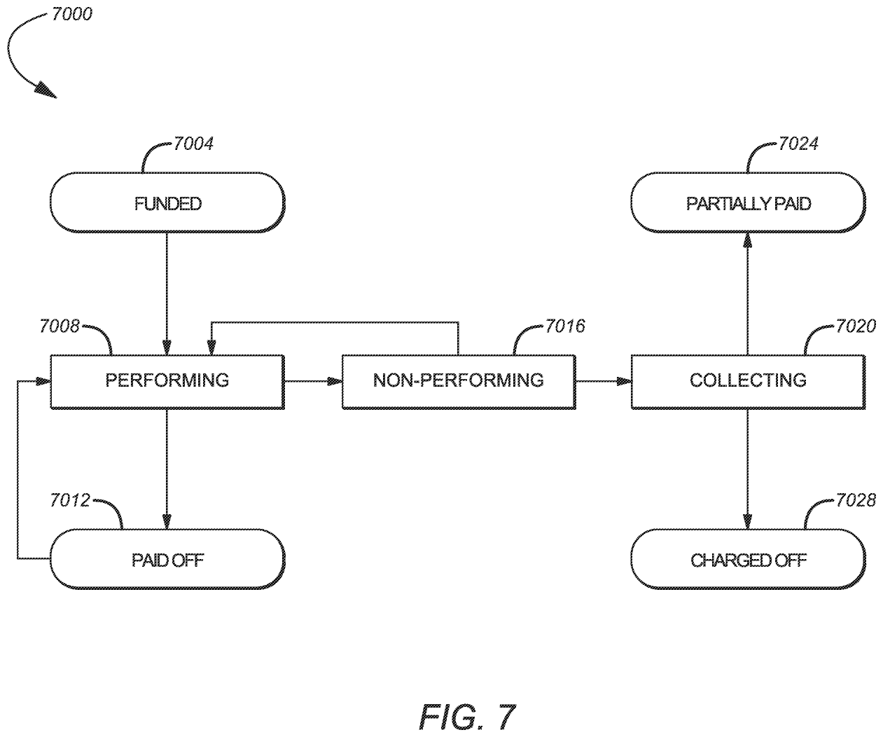

FIG. 7 provides a schematic illustrating a process 7000 by which debtors and representatives of the creditor interact by way of the personal loan-servicing system 2500 in accordance with some embodiments. The process 7000 generally illustrates how a personal loan may be successfully paid off. The process 7000 begins at a funded state 7004 and progresses to performing step 7008 wherein a loan application is converted into a loan, as described with respect to FIG. 6. When the borrower pays off the load, the process 7000 moves to step 7012. However, if there is a payment reversal or non-sufficient funds, the process 7000 moves back to the performing step 7008. If the borrower's payment is late, the process 7000 may move to a non-performing step 7016. When the borrower pays, however, the process 7000 may move back to the performing step 7008.

In some instances, the borrower may fail to make any payments and accrue gross delinquencies. In such cases, the process 7000 may move from step 7016 to a collecting step 7020 wherein a collections process is initiated. If the collections process results in a partially recovered payment, the process 7000 may advance to a partially paid state 7024. If the payment is unrecoverable, however, the process may move to a charged off state 7028.

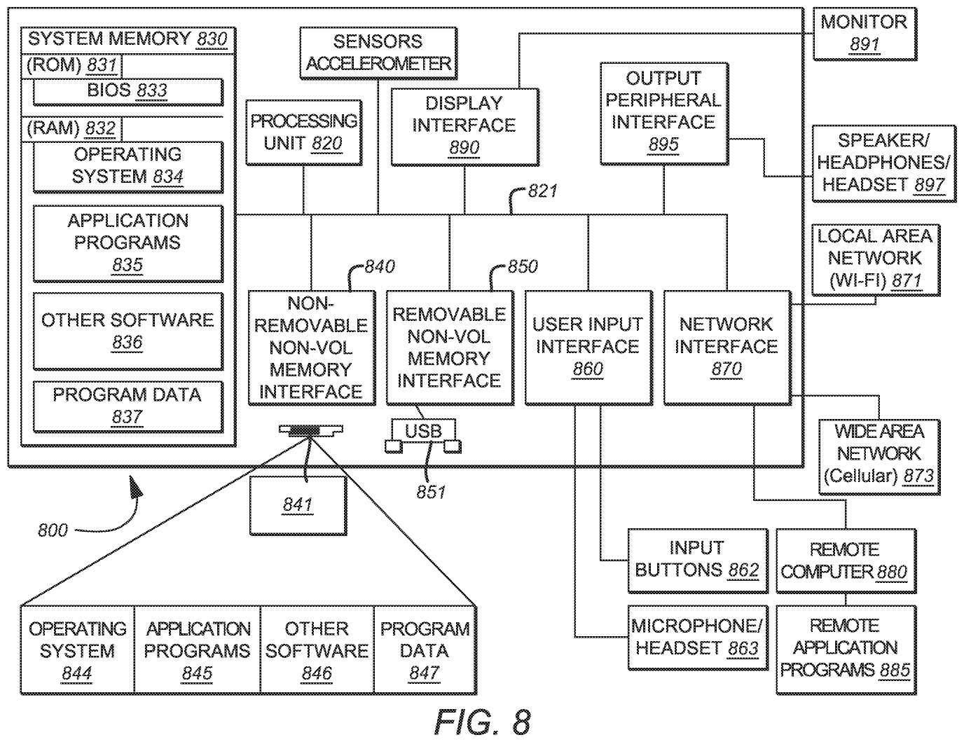

FIG. 8 provides a schematic illustrating components of a network host 800 such as any one or more server hosts of the integrated lending-and-brokering 1000 in accordance with some embodiments. Components of the network host 800 vary in accordance with host type. As such, each and every component shown and described in reference to FIG. 8 need not be included in each host type. Furthermore, each host type can further include components not shown or described in reference to FIG. 8 but otherwise described herein.

As shown, components of the network host 800 can include, but are not limited to, a processing unit 820 having one or more processing cores, a primary or system memory 830, and a system bus 821 that couples various system components including the system memory 830 to the processing unit 820. The system bus 821 can be any of several types of bus structures selected from a memory bus or memory controller, a peripheral bus, and a local bus using any of a variety of bus architectures.

The network host 800 can include a variety of computer-readable media. Computer-readable media can be any media that can be accessed by the network host 800 and includes both volatile and nonvolatile media, as well as removable and non-removable media. By way of example, and not limitation, use of computer-readable media includes storage of information, such as computer-readable instructions, data structures, other executable software, or other data. Computer-readable media includes, but is not limited to, RAM, ROM, EEPROM, flash memory or other memory technology, CD-ROM, digital versatile disks (“DVD”) or other optical disk storage, magnetic cassettes, magnetic tape, magnetic disk storage or other magnetic storage devices, or any other tangible medium that can be used to store the desired information for access by the network host 800. Transitory media such as wireless channels are not included in the computer-readable media. Communication media typically embody computer-readable instructions, data structures, other executable software, or other transport mechanisms and includes any information delivery media. As an example, some client hosts on a network might not have optical or magnetic storage.

The system memory 830 includes computer-readable media in the form of volatile or nonvolatile memory such as read only memory (“ROM”) 831 and random-access memory (“RAM”) 832. A basic input-output system 833 (“BIOS”) containing the basic routines that help to transfer information between elements within the network host 800, such as during start-up, is typically stored in ROM 831. RAM 832 typically contains software or data that are immediately accessible for operations by the processing unit 820. By way of example, and not limitation, FIG. 8 illustrates that RAM 832 can include a portion of the operating system 834, application programs 835, other executable software 836, and program data 837.

The network host 800 can also include other computer-readable media. By way of example only, FIG. 8 illustrates a solid-state memory 841. Other computer-readable media that can be used in the example operating environment include, but are not limited to, universal serial bus (“USB”) drives and devices, flash memory cards, solid state RAM, solid state ROM, or the like. The solid-state memory 841 is typically connected to the system bus 821 through a non-removable memory interface such as interface 840, and USB drive 851 is typically connected to the system bus 821 by a removable memory interface such as interface 850.

The drives and their associated computer-readable media provide storage of computer-readable instructions, data structures, other executable software, or other data for the network host 800. In FIG. 8, for example, the solid-state memory 841 is illustrated for storing operating system 844, application programs 845, other executable software 846, or program data 847. Note that these components can either be the same as or different from operating system 834, application programs 835, other executable software 836, and program data 837. Operating system 844, application programs 845, other executable software 846, and program data 847 are given different numbers here to illustrate that, at a minimum, they are different copies.

A user can enter commands and information into the network host 800 through input devices such as a keyboard, touchscreen, or software or hardware input buttons 862, a microphone 863, a pointing device such as a mouse, or scrolling input component such as a trackball or touch pad. The microphone 863 can cooperate with speech recognition software. These and other input devices are often connected to the processing unit 820 through a user input interface 860 that is coupled to the system bus 821 but can be connected by other interface and bus structures, such as a parallel port, game port, or USB. A display monitor 891 or other type of display screen device is also connected to the system bus 821 via an interface such as a display interface 890. In addition to the monitor 891, the network host 800 can also include other peripheral output devices such as speakers 897 and other output devices, which can be connected through an output peripheral interface 895.

The network host 800 can operate in a networked environment using logical connections to one or more other network hosts such as network host 880. Like the network host 800, the network host 880 can be a personal computer, a server, a router, a network PC, a peer device, or another network node. The logical connections depicted in FIG. 8 can include a local area network (“LAN”) 871 (e.g., Wi-Fi) or a wide area network (“WAN”) 873 (e.g., cellular network). Such networking environments are commonplace in offices, enterprise-wide computer networks, intranets and the Internet. A browser application can be resident on the network host 800 and stored in the memory.

When used in a LAN networking environment, the network host 800 is connected to the LAN 871 through a network interface or adapter 870, which can be, for example, a Bluetooth® or Wi-Fi adapter. When used in a WAN networking environment (e.g., Internet), the network host 800 can include some means for establishing communications over the WAN 873. With respect to telecommunication technologies, for example, a radio interface, which can be internal or external, can be connected to the system bus 821 via the network interface 870, or another appropriate mechanism. In a networked environment, other software depicted relative to the network host 800, or portions thereof, can be stored in the remote memory storage device. By way of example, and not limitation, FIG. 8 illustrates remote application programs 885 as residing on the network host 880. It will be appreciated that the network connections shown are examples and other means of establishing a communications link between the network hosts can be used.

As discussed, the network host 800 can include a processor 820, a memory (e.g., ROM 831, RAM 832, etc.), an AC power input, a display screen, and built-in Wi-Fi circuitry to wirelessly communicate with other network hosts connected to the network.

Another device that can be coupled to bus 821 is a power supply such as a DC power supply (e.g., battery) or an AC adapter circuit. As discussed above, the DC power supply can be a battery, a fuel cell, or similar DC power source that needs to be recharged on a periodic basis. A wireless communication module can employ a Wireless Application Protocol to establish a wireless communication channel. The wireless communication module can implement a wireless networking standard.

In some embodiments, software used to facilitate algorithms discussed herein can be embodied into a non-transitory computer-readable medium. A computer-readable medium includes any mechanism that stores information in a form readable by a computer. For example, a non-transitory machine-readable medium can include ROM; RAM; magnetic disk storage media; optical storage media; flash memory devices; DVDs, EPROMs, EEPROMs, FLASH memory, magnetic or optical cards, or any type of media suitable for storing electronic instructions.

An application described herein includes, but is not limited to, software applications and programs that are part of an operating system or integrated with or on an application layer thereof. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C+, or other similar languages. Also, an algorithm can be implemented with lines of code in software, configured logic gates in software, or a combination of both. In an embodiment, the logic consists of electronic circuits that follow the rules of Boolean Logic, software that contain patterns of instructions, or any combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a network host, or similar electronic computing device, that manipulates and transforms data represented as physical (electronic) quantities within the computer system's registers and memories into other data similarly represented as physical quantities within the computer system memories or registers, or other such information storage, transmission or display devices.

Many functions performed by electronic hardware components can be duplicated by software emulation. Thus, a software program written to accomplish those same functions can emulate the functionality of the hardware components in input-output circuitry.

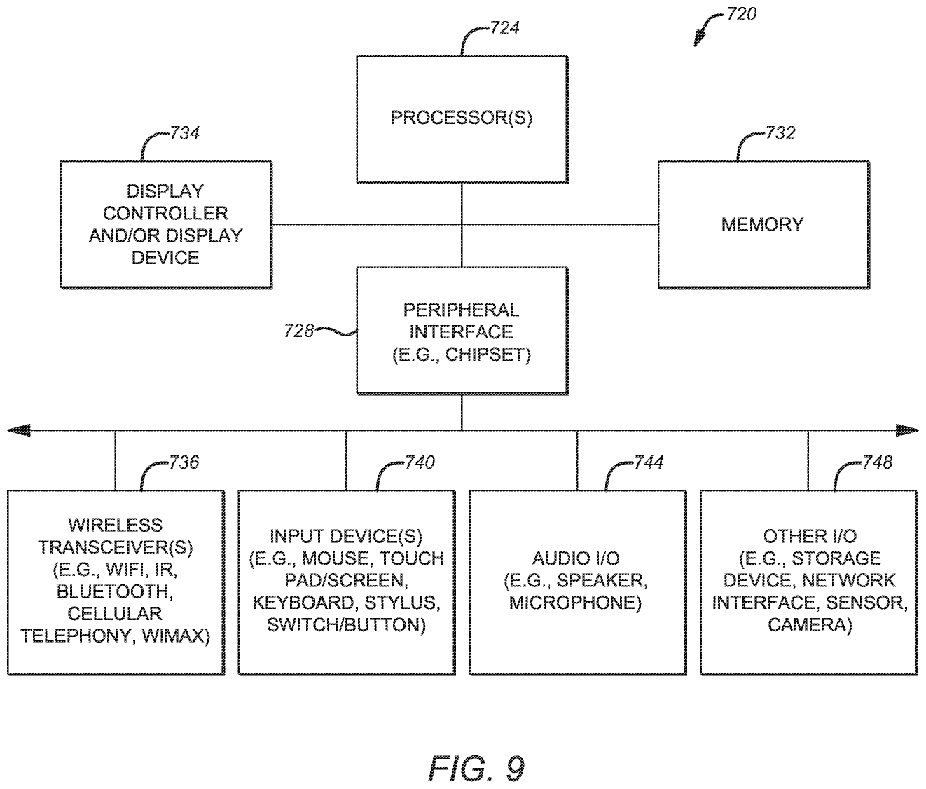

Turning, now, to FIG. 9, a block diagram illustrates an exemplary computing system 720 that may be used in conjunction with the integrated lending-and-brokering environment 1000 to perform any of the processes or methods described herein. System 720 may represent circuitry within a desktop, a tablet, a server, a mobile phone, a personal digital assistant (PDA), a personal communicator, a network router or hub, a wireless access point (AP) or repeater, a set-top box, or any combination thereof.

In an embodiment, illustrated in FIG. 9, system 720 includes a processor 724 and a peripheral interface 728, also referred to herein as a chipset, to couple various components to the processor 724, including a memory 732 and devices 736-748 via a bus or an interconnect. Processor 724 may represent a single processor or multiple processors with a single processor core or multiple processor cores included therein. Processor 724 may represent one or more general-purpose processors such as a microprocessor, a central processing unit (CPU), or the like. More particularly, processor 724 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 724 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 724 is configured to execute instructions for performing the operations and steps discussed herein.

Peripheral interface 728 may include a memory control hub (MCH) and an input output control hub (ICH). Peripheral interface 728 may include a memory controller (not shown) that communicates with a memory 732. The peripheral interface 728 may also include a graphics interface that communicates with graphics subsystem 734, which may include a display controller and/or a display device. The peripheral interface 728 may communicate with the graphics device 734 by way of an accelerated graphics port (AGP), a peripheral component interconnect (PCI) express bus, or any other type of interconnects.

An MCH is sometimes referred to as a Northbridge, and an ICH is sometimes referred to as a Southbridge. As used herein, the terms MCH, ICH, Northbridge and Southbridge are intended to be interpreted broadly to cover various chips that perform functions including passing interrupt signals toward a processor. In some embodiments, the MCH may be integrated with the processor 724. In such a configuration, the peripheral interface 728 operates as an interface chip performing some functions of the MCH and ICH. Furthermore, a graphics accelerator may be integrated within the MCH or the processor 724.

Memory 732 may include one or more volatile storage (or memory) devices, such as random access memory (RAM), dynamic RAM (DRAM), synchronous DRAM (SDRAM), static RAM (SRAM), or other types of storage devices. Memory 732 may store information including sequences of instructions that are executed by the processor 724, or any other device. For example, executable code and/or data of a variety of operating systems, device drivers, firmware (e.g., input output basic system or BIOS), and/or applications can be loaded in memory 732 and executed by the processor 724. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Peripheral interface 728 may provide an interface to IO devices, such as the devices 736-748, including wireless transceiver(s) 736, input device(s) 740, audio IO device(s) 744, and other IO devices 748. Wireless transceiver 736 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 740 may include a mouse, a touch pad, a touch sensitive screen (which may be integrated with display device 734), a pointer device such as a stylus, and/or a keyboard (e.g., physical keyboard or a virtual keyboard displayed as part of a touch sensitive screen). For example, the input device 740 may include a touch screen controller coupled with a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 744 may include a speaker and/or a microphone to facilitate voice-enabled functions, such as voice recognition, voice replication, digital recording, and/or telephony functions. Other optional devices 748 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 748 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 9 illustrates various components of a data processing system, it is not intended to represent any particular architecture or manner of interconnecting the components; as such details are not germane to embodiments of the present disclosure. It should also be appreciated that network computers, handheld computers, mobile phones, and other data processing systems, which have fewer components or perhaps more components, may also be used with embodiments of the invention disclosed hereinabove.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

A non-transitory CRM can include executable instructions that, when executed on one or more server hosts such as the server hosts 5010, 5020, 5030, and 5040 of FIG. 5 by at least an equal number of processors, cause the one or more server hosts to instantiate a personal loan-lending system 2300 configured to perform a number of operations of the personal loan-lending system 2300.

The operations include instantiating a personal loan-originating application stack of a personal loan-originating system 2400 for originating personal loans, instantiating a personal loan-servicing application stack of a personal loan-servicing system 2500 for servicing the personal loans, and providing third-party integration 3400 or 4400 supporting the originating or the servicing of the personal loans. The third-party integration 3400 or 4400 includes one or more APIs configured for transferring loan-related information between the personal loan-lending system 2400 and third parties.

The operations further include operating the personal loan-originating application stack at least in part in a primary memory of at least one server host of the one or more server hosts 5010, 5020, 5030, and 5040. The personal loan-originating application stack includes a web server, an application server, a database server, and an e-mail server.

The operations further include operating the personal loan-servicing application stack at least in part in a same primary memory of the at least one server host or a different primary memory of at least one other server host of the one or more server hosts 5010, 5020, 5030, and 5040. The personal loan-servicing application stack includes a web server, an application server, a database server, and an e-mail server.

The operations further include providing at least a mobile web application by way of the application server. The mobile web application is configured to operate at least in part in a primary memory of a mobile device and present the borrower GUI 3530 within a mobile web browser on a touchscreen of a display of the mobile device. The borrower GUI 3530 is configured to allow potential borrowers to enter borrower-related information into a number of borrower-fillable sections of a digital application.

The operations further include providing at least a web application by way of the application server. The web application is configured to operate at least in part in a primary memory of a personal computer and present the lender GUI 3540 within a web browser on a screen of a monitor associated with the personal computer. The lender GUI 3540 is configured to allow a representative of the lender to review the borrower-related information entered in the number of sections of the digital application.

The operations further include sending secured e-mail messages through the lender GUI 3540 by way of the e-mail server. The lender GUI 3540 is configured to allow the representative of the lender to send the secured e-mail messages with automatic e-mail headers and attachments determined in accordance with a focus in the lender GUI 3540 on a particular borrower and loan process step.

The operations further include transferring to the database server and storing in a database on a storage device of the at least one server host of the one or more server hosts 5010, 5020, 5030, and 5040 borrower-related information held in the number of sections of the digital application. The number of sections of the digital application for the personal loan include a borrower-account registration section, a loan-purpose section, a borrower-profile section, an income-information section, an employment-history section, a banking-information section, or a combination thereof.

The operations further include automatically underwriting with the automatic underwriting module 3570 of the personal loan-originating application stack. The automatic underwriting module 3570 is configured to perform detailed risk assessments in view of the borrower-related information transferred to the database server and stored in the database on the storage device of the at least one server host of the one or more server hosts 5010, 5020, 5030, and 5040.

It is contemplated that, in some embodiments, an artificial intelligence model can be configured to accurately perform one or more of the steps comprising automatically underwriting loans, as described herein. For example, in some embodiments, automatic underwriting module 3570 may further include an artificial intelligence (AI) module that is configured to train one or more AI (e.g., machine learning or other suitable AI) models to perform one or more steps of the invention. In some embodiments, the AI module can be implemented using any of various techniques including, without any limitation, case-based reasoning, rule-based systems, fuzzy models, genetic algorithms, cellular automata, multi-agent systems, swarm intelligence, reinforcement learnings, artificial neural networks, hybrid systems, and the like. In one embodiment, the AI module may employ an artificial neural network to obtain and process fragmented pieces of information, as mentioned above. In some embodiments, the AI module may be trained on dataset(s) representing user account histories and/or previous readjustments, determinations, qualifying offers, weights, metrics, thresholds, qualifying scores, or any other suitable or relevant training data. In some embodiments, the AI module may be trained on the specific user's account(s) and/or credit history.

In some embodiments, the AI module may be configured to self-correct and improve based on a reward feedback circuit for modifying the one or more assigned weights and/or unique thresholds. For example, upon a readjustment of the weights of metrics, the readjustment values can be measured as leading to a desired outcome or undesired outcome according to one or more criteria, then fed back into the AI module as training data. As the AI module further trains on the readjustments it makes and whether those readjustments are desirable or undesirable, the AI module self-corrects and improves as it continues to make readjustments. A wide variety of potential AI module can be employed for such a self-correcting technique. In some embodiments, one or more AI models comprising the AI module may be used in a similar manner for other determinations, computations, and/or predictions within the system. In some embodiments, one or more AI models comprising the AI module may be configured to automatically generate any one or more of metrics, weights, thresholds, tiers, qualifying scores for tiers, qualifying offers, reports, or any other suitable aspect of the systems described herein, without limitation. In some embodiments, such AI models comprising the AI module may be configured to similarly self-correct and improve this generation based on feedback reward circuits.

The operations further include providing a servlet configured to allow the potential borrowers to upload electronic copies or images of documents selected from at least driver's licenses, pay stubs, and bank statements. Each section of the number of sections of the digital application optionally includes a graphical element configured to activate the servlet upon activation of the graphical element by a potential borrower and upload the electronic copes or images of documents.

The operations further include recognizing text in uploaded images of documents with the OCR module 3560 of the personal loan-originating application stack, extracting text from the uploaded images of documents with the OCR module 3560, and providing the text by way of the web server for automated filling of the borrower-related information.

The operations further include automatically depositing personal-loan funds by way of the personal loan-originating system 2400. The borrower-related information from the banking information section transferred to the database server and stored in the database on the storage device of the at least one server host of the one or more server hosts 5010, 5020, 5030, and 5040 is used for automatically depositing the personal-loan funds.

The operations further include automatically setting up monthly ACH payments by way of the personal loan-originating system 2400 on personal loans in accordance with terms of the personal loans. The borrower-related information from the banking information section transferred to the database server and stored in the database on the storage device of the at least one server host of the one or more server hosts 5010, 5020, 5030, and 5040 is used for automatically setting up the monthly ACH payments.

The concepts provided herein including the particular embodiments thereof represent a technological advancement in lending and servicing, particularly lending and servicing with respect to personal loans. The personal loan-lending system 2300 incorporates computer-related technology for tight integration including information sharing between the personal loan-originating system 2400 and the personal loan-servicing system 2500 in order to provide such a technological advancement. At least one example is using borrower-related information for a bank account, or the linked bank account itself, to automatically deposit personal-loan funds in the bank account as well as automatically set up monthly ACH payments to pay down the personal loan.

While the personal loan-lending system and methods have been described in terms of particular variations and illustrative figures, those of ordinary skill in the art will recognize that the personal loan-lending system is not limited to the variations or figures described. In addition, where methods and steps described above indicate certain events occurring in certain order, those of ordinary skill in the art will recognize that the ordering of certain steps may be modified and that such modifications are in accordance with the variations of the personal loan-lending system. Additionally, certain of the steps may be performed concurrently in a parallel process, when possible, as well as performed sequentially as described above. To the extent there are variations of the personal loan-lending system, which are within the spirit of the disclosure or equivalent to the personal loan-lending system found in the claims, it is the intent that this patent will cover those variations as well. Therefore, the present disclosure is to be understood as not limited by the specific embodiments described herein, but only by scope of the appended claims.

What is claimed is:

1. A personal loan-lending system operable by way of a set of executable instructions stored in non-transient machine-readable media of one or more server hosts by at least an equal number of processors, the personal loan-lending system comprising:
a personal loan-originating system configured for originating personal loans;
a personal loan-servicing system configured for servicing the personal loans; and
third-party integration supporting the originating or the servicing of the personal loans.

2. The personal loan-lending system of claim 1, wherein the third-party integration includes one or more application programming interfaces (“APIs”) configured for transferring loan-related information between the personal loan-lending system and third parties.

3. The personal loan-lending system of claim 1, wherein the personal loan-lending system includes one or more server hosts supporting a personal loan-originating application stack and a personal loan-servicing application stack.

4. The personal loan-lending system of claim 1, wherein the personal loan-originating application stack includes a web server, an application server, a database server, and an e-mail server.

5. The personal loan-lending system of claim 4, wherein each of the web server, the application server, the database server, and the e-mail server is configured to operate at least in part in a primary memory of at least one server host of the one or more server hosts.

6. The personal loan-lending system of claim 4, wherein the personal loan-servicing application stack includes a web server, an application server, a database server, and an e-mail server.

7. The personal loan-lending system of claim 6, wherein each of web server, the application server, the database server, and the e-mail server is configured to operate at least in part in a same primary memory of the at least one server host or a different primary memory of at least one other server host of the one or more server hosts.

8. The personal loan-lending system of claim 6, wherein the application server is configured to provide at least a mobile web application configured to operate at least in part in a primary memory of a mobile device and present a borrower graphical user interface (“GUI”) within a mobile web browser on a touchscreen of a display of the mobile device.

9. The personal loan-lending system of claim 8, wherein the borrower GUI configured to allow potential borrowers to enter borrower-related information into a plurality of borrower-fillable sections of a digital application.

10. The personal loan-lending system of claim 9, wherein the application server is configured to provide at least a web application configured to operate at least in part in a primary memory of a personal computer and present a lender GUI within a web browser on a screen of a monitor associated with the personal computer.

11. The personal loan-lending system of claim 10, wherein the lender GUI configured to allow a representative of the lender to review the borrower-related information entered in the plurality of sections of the digital application.

12. The personal loan-lending system of claim 10, wherein the plurality of sections of the digital application include a borrower-account registration section, a loan-purpose section, a borrower-profile section, an income-information section, an employment-history section, a banking-information section, or a combination thereof.

13. The personal loan-lending system of claim 12, wherein each of the plurality of sections is configured to hold the borrower-related information until transferred to the database server and stored in a database on a storage device of the at least one server host of the one or more server hosts.

14. The personal loan-lending system of claim 12, wherein the personal loan-originating application stack includes an automatic underwriting module configured to perform detailed risk assessments in view of the borrower-related information transferred to the database server and stored in the database on the storage device of the at least one server host of the one or more server hosts.

15. The personal loan-lending system of claim 12, wherein the borrower-related information from the banking information section transferred to the database server and stored in the database on the storage device of the at least one server host of the one or more server hosts is later used by the personal loan-originating system for automatically depositing personal-loan funds.

16. The personal loan-lending system of claim 12, wherein the borrower-related information from the banking information section transferred to the database server and stored in the database on the storage device of the at least one server host of the one or more server hosts is later used by the personal loan-servicing system for automatically setting up monthly Automated Clearing House (“ACH”) payments on personal loans in accordance with terms of the personal loans, the terms ranging from 3 to 5 years.

17. The personal loan-lending system of claim 12, wherein each of the plurality of sections of the digital application optionally includes a graphical element configured to activate a servlet upon activation of the graphical element by a potential borrower.

18. The personal loan-lending system of claim 17, wherein the servlet configured to allow the potential borrowers to upload electronic copies or images of documents selected from at least driver's licenses, pay stubs, and bank statements.

19. The personal loan-lending system of claim 18, wherein the personal loan-originating application stack includes an optical character recognition (“OCR”) module configured to recognize text in uploaded images of documents, extract text from the images, and provide the text by way of the web server for automated filling of the borrower-related information.

20. The personal load-lending system of claim 19, wherein the executable instructions, when executed on the one or more server hosts by the at least an equal number of processors, cause the one or more server hosts to instantiate the personal loan-lending system configured to perform a plurality of steps, comprising: instantiating the personal loan-originating application stack of the personal loan-originating system for originating personal loans; instantiating the personal loan-servicing application stack of the personal loan-servicing system for servicing the personal loans; and providing third-party integration supporting the originating or the servicing of the personal loans.
